(19) United States
(12) Patent Application Publication
(10) Pub. No.: US 2010/0044195 A1
(43) Pub. Date: Feb. 25, 2010

(54) POWER STRIP DEVICE AND METHOD FOR CONTROLLING SUCH POWER STRIP DEVICE

(75) Inventors: Yi-Te Chiang, Taipei (TW); Kuang-Che Chen, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/241,280

(22) Filed: Sep. 30, 2008

(30) Foreign Application Priority Data
Aug. 22, 2008 (TW) 097132037

(51) Int. Cl. H01H 63/36; H01R 24/00

(52) U.S. Cl. 200/175; 200/51.04

(57) ABSTRACT

A power strip device and a method for controlling the power strip device are provided. The power strip device is communicated with a host computer. A wireless signal emitter is connected the host computer for emitting a wireless signal. The power strip device has a wireless signal receiver for receiving the wireless signal. The power strip device of the present invention is controlled by detecting the wireless signal.

### FIELD OF THE INVENTION

The present invention relates to a power strip device, and more particularly to a power strip device that is controlled according to a wireless transmission technology.

### BACKGROUND OF THE INVENTION

With increasing development of high technology industries, computers become essential electronic apparatuses in our daily lives. For example, computers can be employed for work or amusement purposes. For a purpose of performing specialized functions, a computer system may also include one or more peripheral devices linked to the host computer. Examples of the peripheral devices include speakers, printers, monitors, scanners or other electronic load products. Usually, the power cords of the host computer and the various peripheral devices are plugged in a multi-outlet power strip device. Since multiple electronic load products are simultaneously plugged in the power outlets of the power strip device, overloading will be a safety problem with the multi-outlet power strip device.

Referring to FIG. 1, a schematic perspective view of a conventional power strip device is illustrated. The power strip device 10 has a manual power switch 100 for enabling or disenabling the multiple power outlets so as to selectively receive or interrupt electricity.

For complying with safety regulations of operating computers, when the computer is powered off, the user needs to manually switch the manual power switch 100 into an open state to interrupt the electricity flowing from the utility power source to the power strip device 10. Since the electricity flowing from the utility power source to the power strip device 10 is interrupted, the hazards resulting from sparking of electric wires are reduced and power consumption is avoided. On the other hand, if the computer users forget to switch the manual power switch 100 into the open state, many load products are still running to consume power and thus the life of these load products may be shortened.

Therefore, there is a need of providing an improved power strip device so as to obviate the drawbacks encountered from the prior art.

### SUMMARY OF THE INVENTION

It is an object of the present invention to provide a power strip device for use with a computer system.

Another object of the present invention provides a power strip device that is controlled according to a wireless transmission technology.

In accordance with an aspect of the present invention, there is provided a power strip device. The power strip device is communicated with a host computer. A wireless signal emitter is connected the host computer for emitting a wireless signal. The power strip device includes a power plug, a wireless signal receiver, at least one automatic power outlet and a control circuit. The power plug is connected to a utility power source. The wireless signal receiver is used for receiving the wireless signal. The automatic power outlet is used for delivering electricity to an electronic load product connected thereto. The control circuit is connected to the wireless signal receiver and the automatic power outlet for controlling on/off statuses of the electronic load product that is connected to the automatic power outlet. If the wireless signal is received by the wireless signal receiver, the automatic power outlet is enabled to deliver electricity to the electronic load product under control of the control circuit. If no wireless signal is received by the wireless signal receiver, the automatic power outlet is disenabled to stop delivering electricity to the electronic load product under control of the control circuit.

In an embodiment, the control circuit includes a control unit, a transistor and a relay. If the wireless signal is received by the wireless signal receiver, the transistor is turned on under control of the control unit such that the relay is closed and the electronic load product that is connected to the automatic power outlet is powered on. If no wireless signal is received by the wireless signal receiver, the transistor is turned off under control of the control unit such that the relay is opened and the electronic load product that is connected to the automatic power outlet is powered off.

In an embodiment, the power strip device further includes a surge protective circuit for protecting the electronic load product that is connected to the power strip device.

In an embodiment, the electronic load product is a computer peripheral device selected from a group consisting of a printer, a monitor, a scanner and a speaker.

In an embodiment, the power strip device further includes a manual power outlet and a manual power switch. The manual power outlet is connected to an additional electronic load product. The manual power switch is manually switched to selectively enable or disenable the manual power outlet so as to power on or off the additional electronic load product.

In an embodiment, the additional electronic load product is an office machine selected from a group consisting of a desk lamp and a faxing machine.

In an embodiment, the wireless signal is a radio frequency signal, a Bluetooth signal or an infrared signal.

In an embodiment, the wireless signal is built in the host computer.

In an embodiment, the wireless signal is inserted into a USB (Universal Series Bus) port of the host computer.

In an embodiment, the control unit determines whether the automatic power outlet is enabled or disenabled according to a predetermined disenabling delay time.

In an embodiment, the automatic power outlet is disenabled if no wireless signal has been received by the wireless signal receiver for a period greater than the disenabling delay time.

In an embodiment, the automatic power outlet is kept enabled to continuously deliver the electricity to the electronic load product if the wireless signal has been received within the disenabling delay time.

In an embodiment, the host computer is a desktop computer.

In an embodiment, the host computer is a notebook computer.

In accordance with another aspect of the present invention, there is provided a method for controlling a power strip device to deliver electricity to an electronic load product that is connected to the power strip device. Firstly, a wireless signal emitter is connected with a host computer. Next, a wireless signal emitted from the wireless signal emitter is detected. If the wireless signal is received by the wireless signal receiver, the automatic power outlet is enabled to deliver electricity to the electronic load product. If no wireless signal is received by the wireless signal receiver, the automatic power outlet is disenabled to stop delivering electricity to the electronic load product.

In an embodiment, the electronic load product is a computer peripheral device selected from a group consisting of a printer, a monitor, a scanner and a speaker.

In an embodiment, the wireless signal is a radio frequency signal, a Bluetooth signal or an infrared signal.

In an embodiment, the method further includes a step of determining whether the automatic power outlet is enabled or disenabled according to a predetermined disenabling delay time.

In an embodiment, the automatic power outlet is disenabled if no wireless signal has been received by the wireless signal receiver for a period greater than the disenabling delay time.

In an embodiment, the automatic power outlet is kept enabled to continuously deliver the electricity to the electronic load product if the wireless signal has been received within the disenabling delay time.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional power strip device;

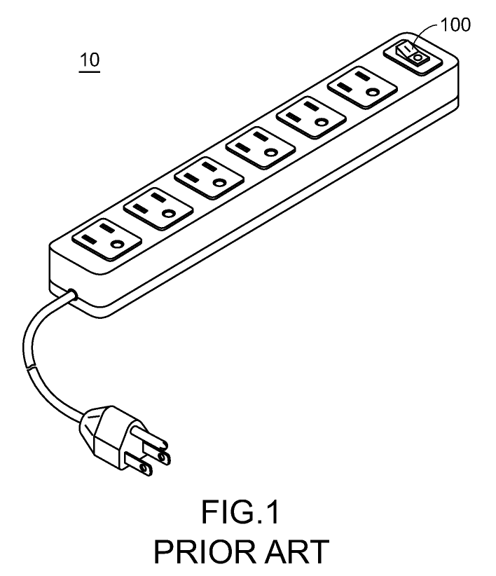

FIG. 2 is a schematic block diagram illustrating a power strip device for use in a computer system according to a preferred embodiment of the present invention; and

FIG. 3 is a schematic perspective view of the power strip device of the present invention.

### DETAILED DESCRIPTION OF THE PREFERRED EMBODIMENT

For overcoming the above described drawbacks resulting from the prior art, the present invention provides an improved power strip device for use with a computer system.

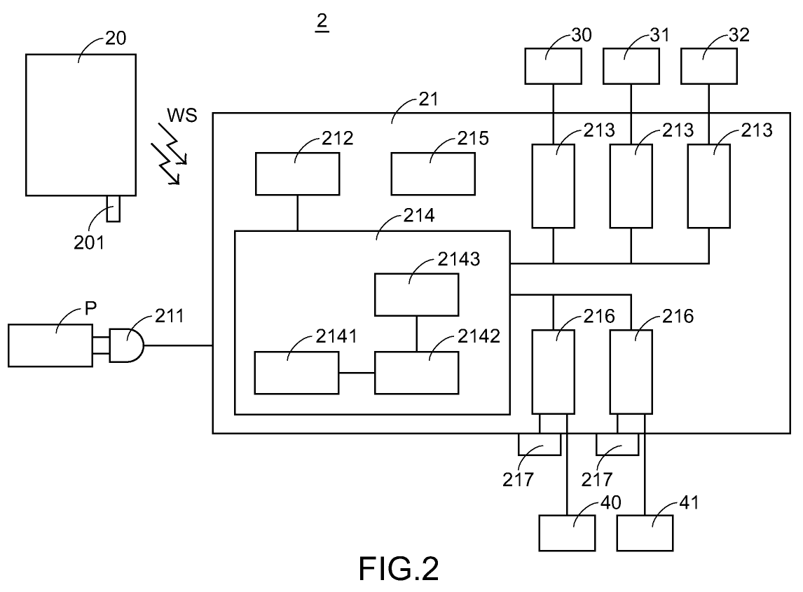

FIG. 2 is a schematic block diagram illustrating a power strip device for use in a computer system according to a preferred embodiment of the present invention. As shown in FIG. 2, the computer system 2 comprises a host computer 20, the power strip device 21 and several electronic load products 30, 31, 32, 40 and 41. The host computer 20 is not electrically connected to the power strip device 21 such that a power source (not shown) provides electricity to the host computer 20 without passing through the power strip device 21. In addition, a wireless signal emitter 201 is connected to the host computer 20 for emitting wireless signals WS. The power strip device 21 comprises a power plug 211, a wireless signal receiver 212, multiple automatic power outlets 213, a control circuit 214, a surge protective circuit 215 and multiple manual power outlets 216. The power plug 211 is electrically connected to a utility power source P. The control circuit 214 is connected to the wireless signal receiver 212, the automatic power outlets 213 and the manual power outlets 216. The wireless signals WS issued by the wireless signal emitter 201 is received by the wireless signal receiver 212. The electronic load products 30, 31 and 32 are plugged in the automatic power outlets 213. As such, electricity will be transmitted to the electronic load products 30, 31 and 32 through respective automatic power outlets 213. The electronic load products 40 and 41 are plugged in the manual power outlets 216. The power strip device 21 has manual power switches 217 for selectively enabling or disenabling the manual power outlets 216 to deliver electricity to the electronic load products 40 and 41. In response to the wireless signals WS, the on/off statues of the automatic power outlets 213 are controlled by the control circuit 214. The surge protective circuit 215 can protect any electronic load product that is connected to the power strip device 21. The operation principles of the surge protective circuit 215 are known in the art, and are not redundantly described herein.

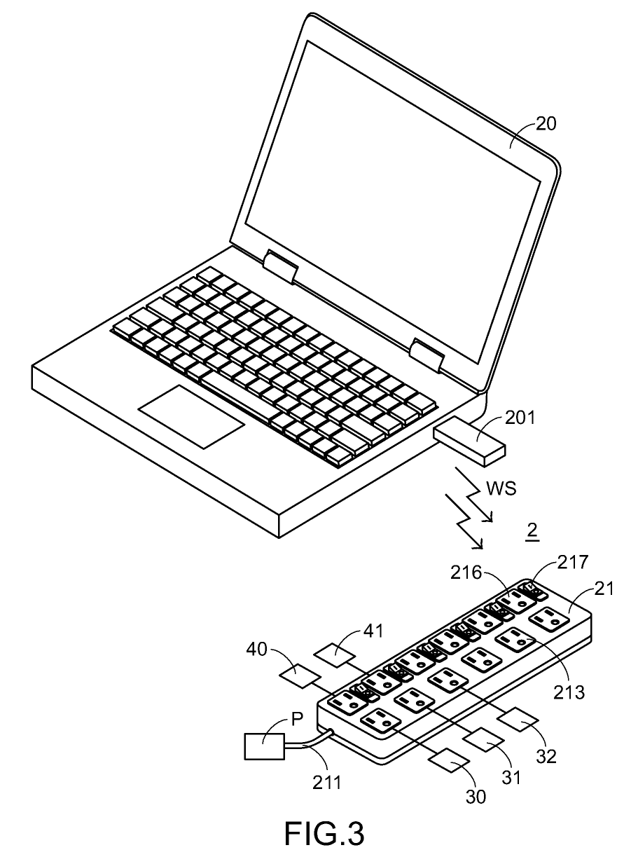

FIG. 3 is a schematic perspective view of the power strip device of the present invention. An exemplary host computer 20 is a notebook computer. The wireless signal emitter 201 is connected to a USB (Universal Series Bus) port of the notebook computer 20. The electronic load products 30, 31 and 32 that are plugged in the automatic power outlets 213 are computer peripheral devices such as a speaker, a printer and a scanner, respectively. The electronic load products 40 and 41 that are plugged in the manual power outlets 216 are office machines such as a desk lamp and a faxing machine, respectively.

Please refer to FIGS. 2 and 3 again. For operating the notebook computer 20, the user may insert the wireless signal emitter 201 in the USB port of the notebook computer 20. During operation of the wireless signal emitter 201, a wireless signals WS is transmitted to the wireless signal receiver 212 of the power strip device 21. After the wireless signals WS is received by the wireless signal receiver 212, the control circuit 214 connected to the wireless signal receiver 212 and the automatic power outlets 213 will enable the automatic power outlets 213 so as to provide electricity to the speaker 30, the printer 31 and the scanner 32. The control circuit 214 comprises a control unit 2141, a transistor 2142 and a relay 2143. The operations of the control circuit 214 will be illustrated as follows. In receipt of the wireless signals WS, the control unit 2141 of the control circuit 214 will turn on the transistor 2142 and thus close the relay 2143. As a consequence, the automatic power outlets 213 are enabled to provide electricity to the computer peripheral devices that are connected thereto. In other words, the relay 2143 may control on/off statuses of the automatic power outlets 213.

On the other hand, if the user intends to temporarily leave the notebook computer or power off the notebook computer 20, the wireless signal emitter 201 may be pulled out of the USB port of the notebook computer 20. Alternatively, when the notebook computer 20 is power off or operated in a hibernation mode, the operation of the wireless signal emitter 201 is stopped. Under this circumstance, the wireless signal receiver 212 will no longer receive the wireless signals WS. If no wireless signal WS is received, the control circuit 214 connected to the wireless signal receiver 212 and the automatic power outlets 213 will disenable the automatic power outlets 213 so as to stop delivering electricity to the computer peripheral devices. In other words, since no wireless signal WS is received, the control unit 2141 of the control circuit 214 will turn off the transistor 2142 and thus open the relay 2143. As a consequence, the automatic power outlets 213 are disenabled to stop flowing electricity to the computer peripheral devices that are connected thereto and the operations of the computer peripheral devices are interrupted.

As known, the procedure of emitting the wireless signal by the wireless signal emitter may consume energy. For reducing power consumption, the wireless signals WS are intermittently issued by wireless signal emitter 201 one by one after a certain time interval or periodically issued in a cycle of several seconds. That is, the wireless signals WS are not continuously emitted in order to reduce power consumption.

Furthermore, the wireless signal receiver 212 has a predetermined disenabling delay time. According to the disenabling delay time, the control unit 214 will determine whether the automatic power outlets 213 need to be enabled or disenabled. For example, if no wireless signal WS has been received by the wireless signal receiver 212 for a period greater than the disenabling delay time, the control unit 214 will disenable the automatic power outlets 213 at the termination of the disenabling delay time, thereby stopping delivering electricity to the computer peripheral devices. On the other hand, if no wireless signal WS has been received by the wireless signal receiver 212 for a period smaller than the disenabling delay time but then received by the wireless signal receiver 212 again, the automatic power outlets 213 are kept enabled so as to continuously deliver the electricity to the computer peripheral devices. Since the wireless signal emitter 201 is possibly detached from the USB port of the notebook computer 20 if the wireless signal emitter 201 is occasionally touched, the predetermined disenabling delay time offers a buffer time for inserting the wireless signal emitter 201 into the USB port of the notebook computer 20 again. In some embodiments, the predetermined disenabling delay time is for example several seconds. It is of course that the predetermined disenabling delay time can be adjusted via an application program.

Please refer to FIGS. 2 and 3 again. The manual power outlets 216 of the power strip device 21 are connected to the electronic load products 40 and 41. By manually switching the manual power switches 217 to an on or off position, the manual power outlets 216 are selectively enabled or disenabled. In an embodiment, the electronic load products 40 and 41 are office machines that are not directly connected to the notebook computer 20.

In the above embodiments, the automatic power outlets of the power strip device of the present invention are selectively enabled or disenabled by detecting whether the wireless signal is received or not. When the computer host is powered on and the wireless signal emitter begins to emit a wireless signal, the automatic power outlets 213 are enabled and thus the computer peripheral devices such as printers, scanners, speakers or monitors (in a case that the host computer is a desktop computer) are automatically turned on. Whereas, when the host computer is powered off or the wireless signal emitter is pulled out of the host computer, the automatic power outlets 213 are disenabled and thus the computer peripheral devices are automatically powered off. In other words, the user needs not to power off all of the computer peripheral devices because the power strip device stops delivering electricity to the computer peripheral devices when the host computer is powered off or the wireless signal emitter is pulled out of the host computer. Moreover, since the power strip device of the present invention is controlled according to a wireless transmission technology, no wire linkage between the power strip device and the host computer is necessary and the troublesome procedure of arranging the wire is omitted.

In the above embodiments, the wireless signals WS is transmitted from the wireless signal emitter 201 to the wireless signal receiver 212 according to a wireless transmission technology. The wireless signals WS is for example a RF (Radio Frequency) signal, a Bluetooth signal or an infrared signal. Corresponding to the wireless signals WS, the wireless transmission technology includes a RF transmission technology, a Bluetooth transmission technology or an infrared transmission technology. The embodiments are illustrated by referring to the external wireless signal emitter. Nevertheless, the wireless signal emitter may be built in the notebook computer.

From the above description, the power strip device of the present invention comprises multiple automatic power outlets and multiple manual power outlets. The manual power outlets are enabled or disenabled by controlling the manual power switches. The automatic power outlets are enabled or disenabled according to wireless transmission control. Depending on the practical situations, the automatic power outlets and the manual power outlets are separately or simultaneously used. In accordance to a key feature of the present invention, the user may simply withdraw the wireless signal emitter to stop transmitting electricity to the electronic load products that are connected to the automatic power outlets if the user intends to temporarily leave the notebook computer. In other words, since the transmission of electricity is automatically stopped, the user needs not to power off all of the electronic load products of the computer system in order to avoid additional power consumption. Moreover, the computer system is easily operated and complies with the requirements of power consumption and environment protection.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power strip device communicated with a host computer, a wireless signal emitter being connected said host computer for emitting a wireless signal, said power strip device comprising:
a power plug connected to a utility power source;
a wireless signal receiver for receiving said wireless signal;
at least one automatic power outlet for delivering electricity to an electronic load product connected thereto; and
a control circuit connected to said wireless signal receiver and said automatic power outlet for controlling on/off statuses of said electronic load product that is connected to said automatic power outlet, wherein if said wireless signal is received by said wireless signal receiver, said automatic power outlet is enabled to deliver electricity to said electronic load product under control of said control circuit; and if no wireless signal is received by said wireless signal receiver, said automatic power outlet is disenabled to stop delivering electricity to said electronic load product under control of said control circuit.

2. The power strip device according to claim 1 wherein said control circuit comprises a control unit, a transistor and a relay, wherein if said wireless signal is received by said wireless signal receiver, said transistor is turned on under control of said control unit such that said relay is closed and said electronic load product that is connected to said automatic power outlet is powered on; and if no wireless signal is received by said wireless signal receiver, said transistor is turned off under control of said control unit such that said relay is opened and said electronic load product that is connected to said automatic power outlet is powered off.

3. The power strip device according to claim 1 wherein said power strip device further comprises a surge protective circuit for protecting said electronic load product that is connected to said power strip device.

4. The power strip device according to claim 1 wherein said electronic load product is a computer peripheral device selected from a group consisting of a printer, a monitor, a scanner and a speaker.

5. The power strip device according to claim 1 wherein said power strip device further comprises:
a manual power outlet that is connected to an additional electronic load product; and
a manual power switch manually switched to selectively enable or disenable said manual power outlet so as to power on or off said additional electronic load product.

6. The power strip device according to claim 5 wherein said additional electronic load product is an office machine selected from a group consisting of a desk lamp and a faxing machine.

7. The power strip device according to claim 1 wherein said wireless signal is a radio frequency signal, a Bluetooth signal or an infrared signal.

8. The power strip device according to claim 1 wherein said wireless signal is built in said host computer.

9. The power strip device according to claim 1 wherein said wireless signal is inserted into a USB (Universal Series Bus) port of said host computer.

10. The power strip device according to claim 1 wherein said control unit determines whether said automatic power outlet is enabled or disenabled according to a predetermined disenabling delay time.

11. The power strip device according to claim 10 wherein said automatic power outlet is disenabled if no wireless signal has been received by said wireless signal receiver for a period greater than said disenabling delay time.

12. The power strip device according to claim 10 wherein said automatic power outlet is kept enabled to continuously deliver the electricity to said electronic load product if said wireless signal has been received within said disenabling delay time.

13. The power strip device according to claim 1 wherein said host computer is a desktop computer.

14. The power strip device according to claim 1 wherein said host computer is a notebook computer.

15. A method for controlling a power strip device to deliver electricity to an electronic load product that is connected to said power strip device, said method comprising steps of:
connecting a wireless signal emitter with a host computer; and
detecting a wireless signal emitted from said wireless signal emitter, wherein if said wireless signal is received by said wireless signal receiver, said automatic power outlet is enabled to deliver electricity to said electronic load product; and if no wireless signal is received by said wireless signal receiver, said automatic power outlet is disenabled to stop delivering electricity to said electronic load product.

16. The method according to claim 15 wherein said electronic load product is a computer peripheral device selected from a group consisting of a printer, a monitor, a scanner and a speaker.

17. The method according to claim 15 wherein said wireless signal is a radio frequency signal, a Bluetooth signal or an infrared signal.

18. The method according to claim 15 further comprising a step of determining whether said automatic power outlet is enabled or disenabled according to a predetermined disenabling delay time.

19. The method according to claim 18 wherein said automatic power outlet is disenabled if no wireless signal has been received by said wireless signal receiver for a period greater than said disenabling delay time.

20. The method according to claim 18 wherein said automatic power outlet is kept enabled to continuously deliver the electricity to said electronic load product if said wireless signal has been received within said disenabling delay time.
